(19) United States
(12) Patent Application Publication
(10) Pub. No.: US 2003/0024334 A1
(43) Pub. Date: Feb. 6, 2003

(54) Gearbox

(76) Inventor: Jurgen Wafzig, Eriskirch (DE)

Correspondence Address: DAVIS & BUJOLD, P.L.L.C., FOURTH FLOOR, 500 N. COMMERCIAL STREET, MANCHESTER, NH, 03101-1151, US

(21) Appl. No.: 10/209,793

(22) Filed: Jul. 31, 2002

(30) Foreign Application Priority Data
Jul. 31, 2001 (DE) 101 37 357.0

(51) Int. Cl. F16H 3/08

(52) U.S. Cl. 74/329

(57) ABSTRACT

The invention is based on a gear transmission with an input drive shaft (7) and coaxial thereto an output shaft (8) and a counter shaft (9) provided parallel to the two shafts, whereby the input drive shaft (7), via a shiftable gear sets (I to V and R) with, respectively, a fixed gear (10 to 14 and 22) and an idler gear (15 to 19 and 23) can be, in a driveable manner, connected with the counter shaft (9), which latter, via a constant gear set (K) is in continual connection with the output shaft (8). Proposed is, that a gear set (R) for reverse travel be placed on the input side of the gear transmission and that the sixth gear (6) can be shifted to form a direct gear through a shifting clutch (f), which, in its shifted condition connects the input drive shaft (7) directly with the output shaft (8) or with a fixed gear (20) on the output shaft (8).

The invention concerns a gear transmission in accord with the principal concept of claim 1.

Gear transmissions constructed in the counter shaft mode, from a design viewpoint, and with special consideration of the price, make a very favorable selection for transmissions. Each of these transmissions possess, as a rule, an input drive shaft and an output drive shaft, as well as a counter shaft installed parallel to the said input and output shafts. The force flow proceeds through a gear set from the input shaft to the counter shaft and from there to the output shaft, by way of a further gear set. One of the gear sets, which is involved in all gears, possesses two fixed gears, which engage each other and respectively are seated on the counter shaft, the input shaft or the output shaft. The other gear set possesses an idler gear and a fixed gear. This latter gear set, generally, is assigned to one gear position. The gear set for reverse travel has also an intermediate gear, which, on the one hand, engages the idler gear and otherwise meshes with the fixed gear, whereby it effects a reversal of the direction of rotation. As a rule, the fixed gears for forward gears and the reverse gear are seated on the counter shaft, while the idler gears are carried by the input shaft or the output shaft and by means of shifting clutches can be coupled to the appropriate shaft.

In order that a vehicle motor, during travel, can run in an optimal operation range, transmissions with a multiplicity of gears are desirable, whereby the stage jumps between the individual gears, from the highest gear to the lowest gear progressively increase. This advantage, along with a small stepped staging, permits the driver to possess, in that range wherein the greatest part of the driving is carried out, a better fit between speed and gear position. Further the entire gear ratio range between the first and the highest gear, in spite of a small number of gears is as great as possible.

In order to fulfill these requirements, multi-gear transmissions which are made in the counter shaft construction mode are known, for which, besides a constant gear set and a reverse gear, one separate gear set is required for each forward gear. There is even a six-gear counter shaft transmission known for trucks, (see Construction Book, Vol. 26, Page 4, Johannes Loomann, “Zahngetriebe” 1970, Springer Verlag, Berlin), in which a constant gear set is placed on the input shaft side of the transmission. The fixed gear seated on the input drive shaft of this said gear set can be coupled with the output shaft by means of a shifting element, whereby the output drive is connected directly with the input drive shaft, thus forming a direct sixth gear. The changeover gear set for the reverse gear lies on the output side of the transmission. Such a transmission requires for six forward gear positions, only five gear sets.

Thus, the invention has the purpose of making available a large gear ratio range with as few gear sets as possible for a gear transmission made in the counter shaft construction mode and having one output side gear set with a constant gear ratio. This purpose is achieved, in accord with the invention, by the features of claim 1. Further embodiments are made evident in the subordinate claims.

In accord with the invention, a gear set for the reverse gear is placed on the input gear shaft side and the sixth gear serves as a direct gear by means of a shifting clutch. This gear, in the shifted condition connects the input drive shaft directly with the output drive shaft or with a fixed gear seated on the output gear. This arrangement permits the elimination of one gear set, even if the constant gear set is placed on the output side of the transmission. By means of the output side placement of the constant gear set, the shifting elements, which as a rule are designed as synchronized dog clutches, lie on the motor side of the transmission and make possible low shifting forces, in spite of cost-saving, single cone-clutch synchronization. In the case of the invented gear transmissions, which have a constant gear stage on the output side, the size of the transmission, its weight and the costs show a reduction, when compared to conventional gear transmissions.

In accord with one embodiment of the invention, the shifting elements and the idler gears of the first gear, the second gear and the reverse gear are all placed on the counter shaft. In this way, the relative speeds of rotation upon shifting into the direct gear are reduced, so that means for lubrication and cooling of the synchronization can be eliminated. This reduces likewise, the manufacturing and other associated costs of the transmission.

To achieve favorable gear ratios of the gear sets, the invention proposes, that the constant gear set have a ratio of 0.39, the gear set of the first gear of 3.5, the gearset of the second gear of 2.04, the gear set of the third gear a ratio of 1.23, the gear set for the fourth gear of 0.82, and that the gear set for the reverse gear show a ratio of 3.26. In this way, there is available an advantageous progressive gear staging of φ=1.71 to φ=1.43. Further, there is a gear ratio range of 9 in the first gear to 1 in the sixth gear. The reverse gear has a ratio of 8.4. The ratios of the gear sets can vary slightly from the above given values, both upward and downward, without losing the advantages of the invention on this account. Beyond this, it is possible, that by the elimination or addition of gear sets, gear transmissions with less or more gears can be can be realized.

Further advantages become evident from the following descriptions with the aid of the drawing. In the drawing are presented embodiment of the present invention. The description and the claims contain a multitude of features in combination. The expert will regard the features individually and reassemble them in new combinations. There is shown in:

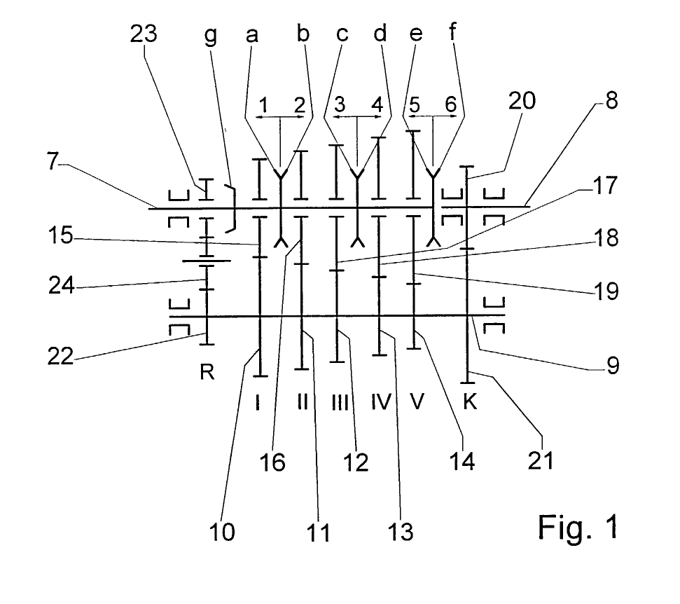

FIG. 1 a transmission scheme of an invented gear transmission;

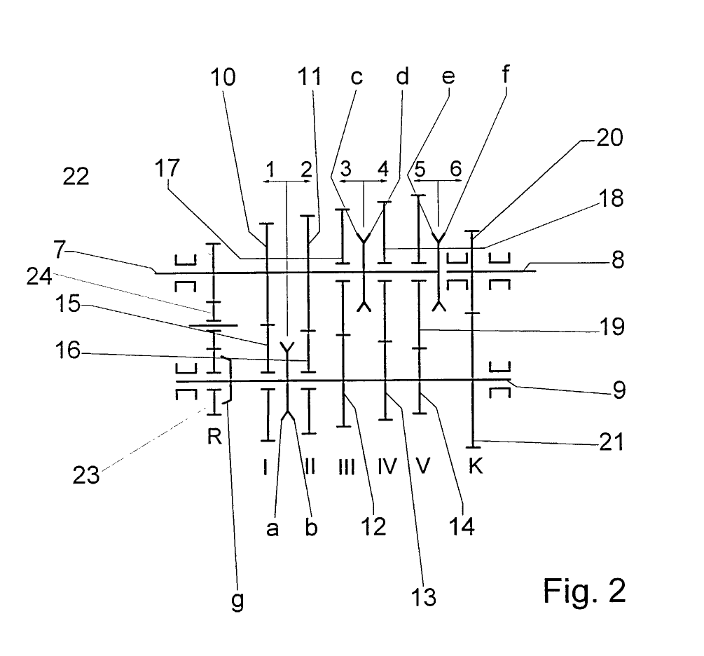

FIG. 2 a variant on FIG. 1; and

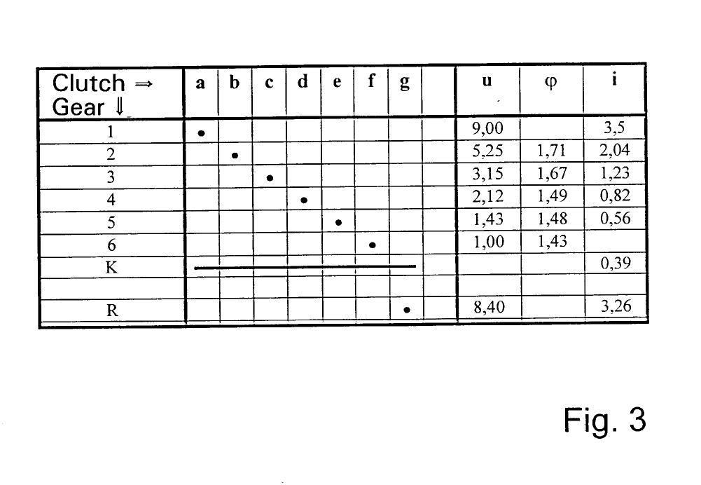

FIG. 3 a tabulated shifting logic and favorable ratios of the gear sets.

The transmission in accord with FIG. 1, possesses an input drive shaft 7 and, coaxial thereto, is positioned an output shaft 8. Parallel to these two said shafts is installed a counter shaft 9, which is carried in a (not shown) transmission housing. The transmission further possesses, in total, seven gear sets, namely I to V, and V, R, K. The gear set K has a fixed gear 20 on the output shaft 8 and a fixed gear 21 on the counter shaft 9. The gear sets I to V include fixed gears 10 to 14, which, in the depiction of FIG. 1 are seated on the counter shaft 9 and mesh continually with the idler gears 15 to 19, which are on the input shaft 7 and, by means of shifting clutches a to e, can be coupled on option with the input drive shaft 7. In this way, a forward gear selection 1 to 5 is formed by respectively gear sets I to V and the constant gear set K. At the end of the input drive shaft 7 is to be found a shifting element f, with which the input shaft 7 can be coupled with the output shaft 8 or with the fixed gear 20, which is affixed on the output drive shaft 8. Thereby, the highest gear, that is the sixth gear 6, is obtained by shifting as a direct drive gear.

On the input side of the gear transmission is located a gear set R for reverse action. This gear set possesses a fixed gear 22 on the counter shaft 9 and an idler gear 23 on the input drive shaft 7, which is operated by a shifting clutch g. Between the idler gear 23 and the fixed gear 22 of the gear set R is provided an intermediate gear 24, which meshes with the said two gears and thereby effects a reversal of the counter shaft 9.

The embodiment shown in FIG. 2 differentiates itself from the embodiment of FIG. 1, in that the fixed gear 10 and the fixed gear 11 of the first gear, and the second gear, respectively, are seated on the input drive shaft 7 and accordingly the idler gears 15 and 16 of the gear sets 1 and 11 are located on the counter shaft 9. Subsequent to this, the shifting elements a and b are assigned to the counter shaft 9.

Further the fixed gear 22 of the gear set R is seated on the input shaft 7, while the idler gear 23 and the shifting clutch g responsive thereto are connected to the counter shaft 9. In FIG. 3, the shifting logic of the gear transmission is made evident. In the middle position of the shifting elements a to g, the gear transmission finds itself in the neutral position, in which it transmits no torque. If the clutch element is activated, then the shift is to the first gear. Upon the activation of the shifting gear b, the second gear 2 is energized. The shift sequence proceeds in this indicated manner. In the case of ratio i, of the gear sets I to V for the gears 1 to 5 and the constant gear set K, as well as the gear set for the reverse gear R, corresponding to the last column of the table, there is effected the transmission reduction ratio u, as may be seen in the third last column of the table. The next to the last column in the table shows that the transmission stepping jump φ lies in the zone between 1.71 and 1.43 and increases progressively from the sixth gear to the first gear. Thus, a six-gear transmission has been achieved with a large ratio range of 9, wherein the gear stepping in the upper three gears lies between 1.49 and 1.43, while the stepping jump φ between the first and the second gear runs at 1.71 and between the second and the third gear the jump is 1.67. Thereby, a comfortable driving performance of the vehicle is attained.

Reference Numbers and Associated Components

Reference Numbers and Associate Components

| 1 | first gear |
|---|---|
| 2 | second gear |
| 3 | third gear |
| 4 | fourth gear |
| 5 | fifth gear |
| 6 | sixth gear |
| 7 | input shaft |
| 8 | output shaft |
| 9 | counter shaft |
| 10 | first fixed gear |
| 11 | second fixed gear |
| 12 | third fixed gear |
| 13 | fourth fixed gear |
| 14 | fifth fixed gear |
| 15 | first idler gear |
| 16 | second idler gear |
| 17 | third idler gear |
| 18 | fourth idler gear |
| 19 | fifth idler gear |
| 20 | fixed gear |
| 21 | fixed gear |
| 22 | fixed gear |
| 23 | idler gear |
| 24 | intermediate gear |
| I | gear set |
| II | gear set |
| III | gear set |
| IV | gear set |
| R | gear set |
| K | gear set (constant) |
| a | first shifting clutch |
| b | second shifting clutch |
| c | third shifting clutch |
| d | fourth shifting clutch |
| e | fifth shifting clutch |
| t | sixth shifting clutch |
| g | seventh shifting clutch |
| u | gear ratio reduction |
| Φ | jump between gear steps |
| i | gear ratio |

Claimed is:

1. A gear transmission with an input drive shaft (7), an output shaft (8) coaxial thereto and a provided counter shaft (9), which is parallel to the said two shafts, wherein the input shaft (7), by means of shiftable gear sets (I to V and R) which have respectively a fixed gear (11 to 14 and 22) and an idler gear (15 to 19 and 23), can be, in a driveable manner, connected to the counter shaft (9), which by means of a constant gear set (K) continuously engages the output shaft (8), therein characterized, in that a gear set (R) for reverse travel is located on the input side of the gear transmission and in that the sixth gear (6) is shifted by a shifting clutch (f) as a direct gear, which, in the said shifted condition connects the input shaft (7) directly with the output shaft (8) or with a fixed gear (20) on the output shaft (8).

2. A gear transmission in accord with claim 1, therein characterized, in that all shifting elements (a to g) and idler gears (15 to 18 and 23) are responsive to the input drive shaft (7).

3. A gear transmission in accord with claim 1, therein characterized, in that the shifting elements (a, b, g) and idler gears (15, 16, 23) of the first gear (1), of the second gear (2) and the reverse gear (R) are assigned to the counter shaft (9).

4. A gear transmission in accord with one of the foregoing claims, therein characterized, in that the gear ratio for the constant gear set (K) is 0.39, for the gear set (I) of the first gear (1) the ratio is 3.5, for the gear set (II) of the second gear (2), the value is 2.04, for the gear set (III) of the third gear (3) the ratio is 1.23, for the gear set (IV) of the fourth gear (4) the value is 0.82, for the gear set (V) of the fifth gear, the ratio is 0.56 and for the gear set (R) for the reverse travel, the gear ratio is 3.26.
